(19) United States
(12) Patent Application Publication
(10) Pub. No.: US 2024/0029147 A1
(43) Pub. Date: Jan. 25, 2024

(54) Closet Assistant Mobile Application and Web Services

(71) Applicant: Ryan Lasek, Havre De Grace, MD (US)

(72) Inventor: Ryan Lasek, Havre De Grace, MD (US)

(21) Appl. No.: 17/868,178

(22) Filed: Jul. 19, 2022

(51) Int. Cl. G06Q 30/06; G06F 21/62; G06Q 50/00

(52) U.S. Cl. CPC G06Q 30/0641; G06F 21/6209; G06Q 50/01; G06F 2221/2133

(57) ABSTRACT

An article of manufacture for a mobile application and web services to assist sellers maintain an online sales business on a Poshmark social media site according to the present invention is disclosed.

### CROSS-REFERENCES TO RELATED APPLICATIONS

This application claims the benefit of provisional application No. 63/121,112 entitled CLOSET ASSISTANT MOBILE APPLICATION AND WEB SERVICES, filed Dec. 3, 2020. The provisional application is incorporated in its entirety by reference.

### FIELD OF INVENTION

This application relates in general to a system and method for providing a mobile application and web services to assist sellers maintain an online sales business on a Poshmark social media site.

### BACKGROUND OF THE INVENTION

Poshmark is a social commerce marketplace where users in the US, Canada, Australia, and India can buy and sell new or used clothing, shoes, and accessories. The Poshmark employs algorithms that respond to a listing for sale being shared by placing the share listing at the top of the items for sale in the platform. Any Poshmark user can share an item, include the item's seller. Items can be shared throughout the Poshmark platform and can be shared to Poshmark Parties.

Sellers spend countless hours a day sharing your closet in order to sell goods to buyers over the Internet. Because of this time requirement, services that provide virtual assistants have started providing assistance to sellers. However, virtual assistant are very expensive and may not provide sellers much more than they can do for themselves. Existing solutions attempt to use software bots to automate various steps in the process; however, none of the available solutions have addressed all the needs of sellers.

Additionally, the security of a seller's account presents an important consideration in selecting a Poshmark virtual assistant or Poshmark Bot, as they generally require access to the seller's account. These accounts contain banking information, sales history, balance, and business strategy that may become visible to third-parties or employees of these Poshmark virtual assistant businesses.

There exists a need to improve upon existing Poshmark virtual assistants and Bots to provide a more complete and more secure user experience.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention attempts to address the existing limitations in online sales of merchandise according to the principles and example embodiments disclosed herein. Some embodiments of the present invention pertain to a mobile application and web services to assist sellers in maintaining an online sales business on a Poshmark social media site.

### BRIEF DESCRIPTION OF THE DRAWINGS

The present invention is described in detail below with reference to the attached drawing figures, wherein:

FIG. 1 provides a block diagram according to an exemplary embodiment of the present invention.

FIG. 2 is a flow chart illustrating an exemplary method in accordance with aspects of the present invention.

FIG. 3 illustrates a computer system 800 adapted according to certain embodiments of the present invention.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

The present invention attempts to address the existing limitations in online sales of merchandise according to the principles and example embodiments disclosed herein. Some embodiments of the present invention pertain to a mobile application and web services to assist sellers in maintaining an online sales business on a Poshmark social media site.

The term “user” and “seller” refers to an entity, e.g. a human, that utilizes a mobile application and web services according to the present invention in order to bring about a desired effect or outcome, particularly provide the user an ability to support an instrument. In a particular case, the user is one utilizes a mobile application and web services to assist sellers maintain an online sales business on a Poshmark social media site disclosed herein. For such a user, the terms “user” and “seller” may be used herein interchangeably.

The term “Closet Assistant” may be used herein to refer to some embodiments of the present invention. The Closet Assistant may consist of a set of software tools that are a combination of web-based software components and a user application that typically is part of a mobile application and web services.

The embodiments of the present invention comprise a software application to assist Poshmark Sellers is various tasks. Tasks include, but are not limited to, updating notice boards and direct live messages, providing a dashboard wherein statistics on daily user activity within the software may be displayed, a menu display which streamlines user experience by organizing features with menu groupings, tools for sharing and updating listings, following and unfollowing users, liking accounts and items, placing comments on accounts and listings. The Closet Assistant also may be used via a web browser to the Closet Assistant web services.

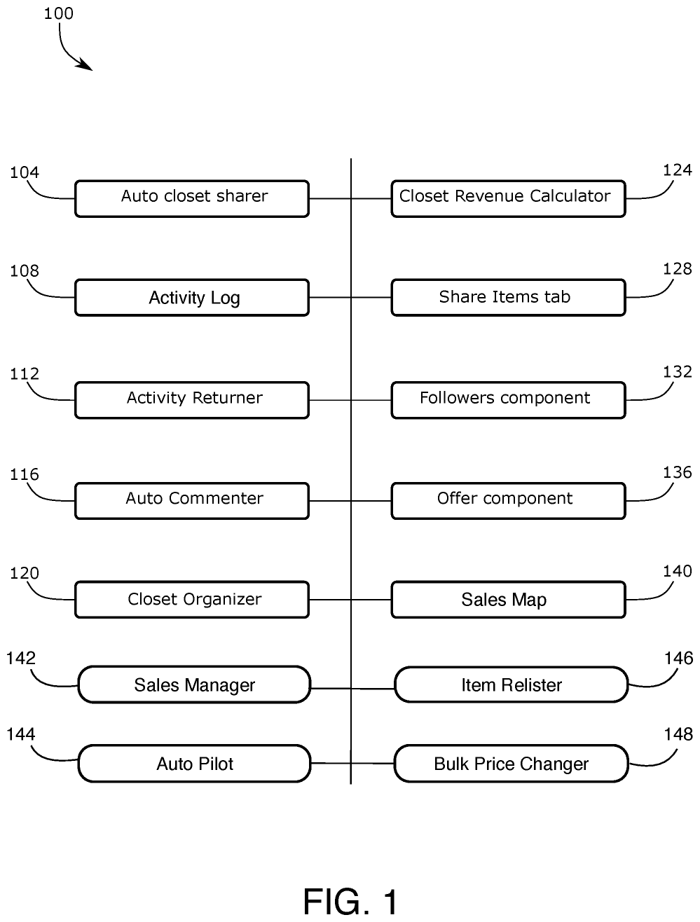

FIG. 1 provides a block diagram 100 according to an exemplary embodiment of the present invention. Closet Assistant offers a series of automated tools for the Poshmark seller. The main component of Closet Assistant is its auto closet sharer 104. The auto closet sharer 104 may share seller's closet as well as other Poshmark user's closets with a single click. As a result, sellers no longer need to spend countless hours a day sharing their closet.

The software components of the Closet Assistant include an Activity Log 108, an Activity Returner 112, an Auto Commenter 116, a Closet Organizer 120, a Closet Revenue Calculator 124, a Share Items tab 128, a Followers component 132, Make an offer component 136, and a Sales Map component 140.

The closet assistant provides various automated functionality, including organize closet, seller stats, automatic captcha solving, sharing, following and unfollowing, commenter, notice board and live message updates, dashboard, menu display, like items, activity returner, make an offer, closet revenue calculator, task scheduler, sales manager 142, auto pilot 144, items re-lister 146, bulk price changer 148, report a bug, settings panel, accounts panel, subscriptions panel.

The Organize Closet function allows automatic organization of the order in which items are displayed within a user's accounts according to brand, custom, and price. The Seller Stats function displays sales reports, inventory reports, sales map by location and order details in a user-friendly manner

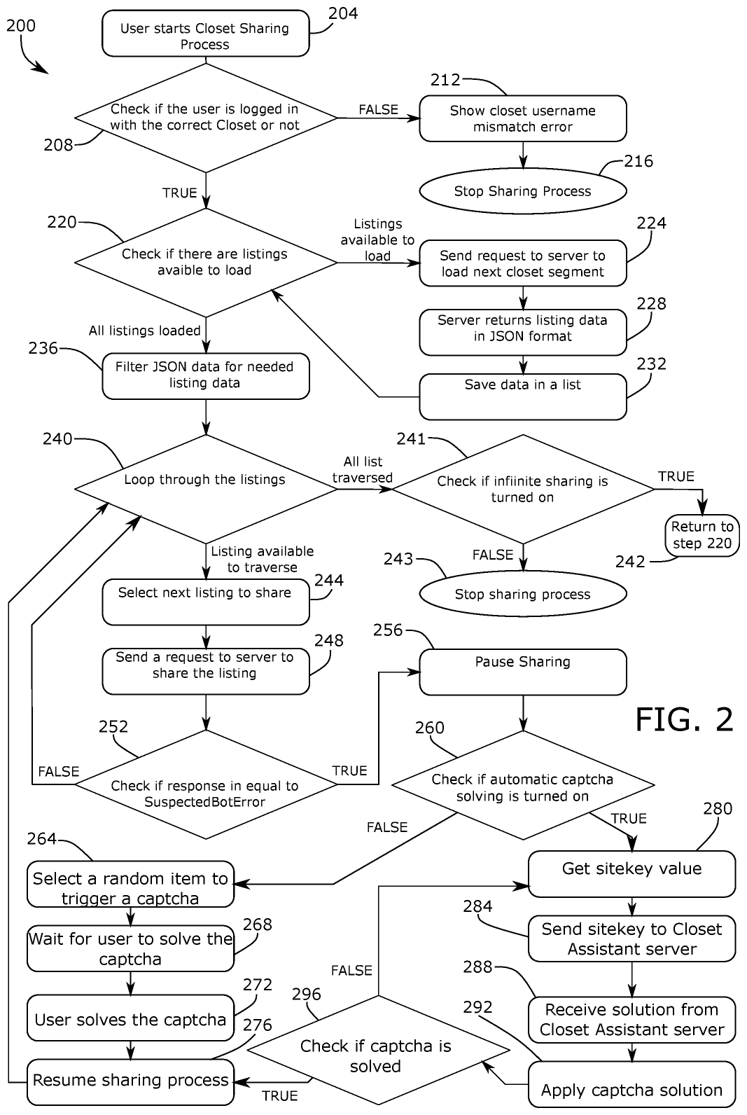

FIG. 2 is a flow chart 200 illustrating an exemplary method in accordance with aspects of the present invention. At step 204, a user initiates the Closet Sharing Process. At decision point 208, the Closet Assistant checks if the user is logging in with the correct Closet. If the log in information is incorrect, the method proceeds to step 212, wherein the Closet Assistant displays a closet/username mismatch error, at which point to the method proceeds to end point 216 and stops the sharing process.

If, at decision point 208, it is determined that the user is logged in with the correct closet, the method proceeds to decision point 220, wherein the method checks if there are listings available to load. If there are listings to load, the method proceeds to step 224, wherein the Closet Assistant sends a request to the Poshmark servers to load the next closet segment. In some embodiments, the Closet Assistant may load listings of a user's closet using Java script or equivalent scripting language to send a request to https://poshmark.com/vm-rest/users/{username}posts/filtered?request={appliedfilters} to get the first listings.

In order to get the users closet information like the number of followers, listings, likes or shares, at step 224 the Closet Assistant may send a request on the following end point: https://poshmark.com/vm-rest/users/{username}, where {username} represents the users closet username. At step 228, the Poshmark servers return the requested data in JSON format. At step 232, the JSON data received is stored to a list. The method then proceeds back to decision point 220 to determine if there are further listings to load. This 220, 224, 228, 232 loop continues until all listings are loaded. At which point, the method proceeds to step 236, where the list of JSON data for the listing is filtered to remove data that is not required for sharing an item such as the number of likes, shares, picture URLs, date created, etc.

At decision point 240, the method initiates a loop through the listing. As long as there are listings still to be traversed, the method selects the next listing to share at step 244. At step 248, a request is sent to the Poshmark server to share the selected listing. At decision point 252, the response from the Poshmark server is checked to determine if the response value is equal to SuspectedBotError. If no SuspectBotError response is received, the method returns to decision point 240 to continue traversing the list. If a SuspectBotError is received, the sharing procedure is pause at step 256. At decision point 260, the method checks if automatic captcha solving has been turned on.

If automatic captcha solving is not turned on, a random item is select from the listings in order to trigger a captcha challenge at step 264. At step 268, the method waits for the user to solve the captcha. The user then solves the captcha at step 272. At step 276, the sharing process in resumed and the method returns back to decision point 240 to continue traversing the list.

Returning to decision point 260, if automatic captcha solving is turned on, the method gets the sitekey value at step 280. At step 284, the sitekey is sent to the Closet Assistant server. At step 288, the Closet Assistant server returns the solution to the captcha based on the received sitekey.

At step 292, the received captcha solution is applied automatically. At decision point 296, the method checks if captcha has been successfully solved. If not, the method returns back to step 280 to get the new sitekey value add proceeds as before. If the captcha has been successfully solved, the method processed to step 276 and the sharing process resumes as discussed above.

Returning to discussion point 240, the process laid out here continues until the full list of listing items has been traversed. At that point, the method proceeds to decision point 241 to check if infinite sharing is turned on. If not, the sharing process stops at end point 243. If infinite sharing is turned on, the method returns to decision point 220 to determine if there further listing available to load.

Embodiments of the present invention include additional features that use variations of the workflow laid out in FIG. 2. The activity returner uses the same flow of loading the closet listings and based on the activity it either likes the item or share using the same technique as in sharing flow. The closet organizer uses the same flow step by step to load listings but additionally organizes items as they are loaded based on user selected preferences. The auto pilot scheduled sharing feature triggers the workflow of FIG. 2 based on a predefined time. One having skill in the art would see how such functionality could be implemented with relation to the workflow in FIG. 2.

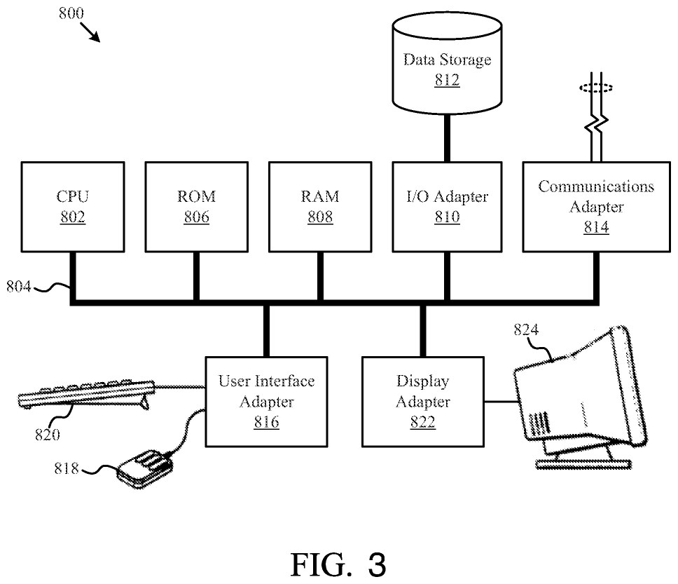

FIG. 3 illustrates a computer system 800 adapted according to certain embodiments of the present invention. The central processing unit (“CPU”) 802 is coupled to the system bus 804. The CPU 802 may be a general-purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid-state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

A server hosting an emulated software environment for virtualization according to one embodiment of the disclosure operates as follows. An operating system executing on a server includes drivers for accessing hardware components, such as a networking layer for accessing the communications adapter. The operating system may be, for example, Linux. An emulated environment in the operating system executes a program, such as CPCommOS. The program 910 accesses the networking layer of the operating system through a non-emulated interface, such as XNIOP. The non-emulated interface translates requests from the program executing in the emulated environment for the networking layer of the operating system.

In another example, hardware in a computer system may be virtualized through a hypervisor. Users may access the hardware through a hypervisor. The hypervisor may be integrated with the hardware to provide virtualization of the hardware without an operating system. The hypervisor may provide access to the hardware, including the CPU and the communications adaptor.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A computer implemented method comprising:
checking whether a user is logging in with a specified closet;
upon determining that the user is logged in with the specified closet, checking whether there is a closet segment to load to a hosting server; wherein the closet segment comprises one or more listings available in the specified closet;
upon determining that there is a closet segment for loading to the hosting server, sending a request to the hosting server to load the closet segment;
sending a request to get the user's closet information including at least one of the number of followers, listings, likes and share;
receiving the user's closet information in JSON format from the hosting server;
storing the JSON formatted information to a list;
filtering list of JSON information for the to remove data that is not required for sharing an item;
selecting a next listing to share and sending to the hosting server to share the next listing;
checking a response value from the hosting server to determine if the response value is equal to SuspectedBotError;
upon determining the response value is equal to SuspectedBotError, getting a sitekey value;
returning a solution to a captcha challenge based on the sitekey; and
applying the solution is applied the captcha challenge.

2. The method of claim 1, wherein:
sending the request to the hosting server to load the closet segment may comprise using a scripting language to send a request to https://poshmark.com/vm-rest/users/{username}posts/filtered?request={appliedfilters}.

3. The method of claim 2, wherein the scripting language is Java script.

4. The method of claim 1 wherein:
the request to get the users closet information is sent to https://poshmark.com/vm-rest/users/{username}, where {username} represents the user's closet username.

5. The method of independent claim 1 wherein:
data that is not required for sharing an item comprises at least one of a number of likes, shares, picture URLs, and date created.
